(19) United States
(12) Patent Application Publication
(10) Pub. No.: US 2014/0257687 A1
(43) Pub. Date: Sep. 11, 2014

(54) PYRAMID MAPPING DATA STRUCTURE FOR INDOOR NAVIGATION

(71) Applicant: QUALCOMM INCORPORATED, San Diego, CA (US)

(72) Inventors: Jiajian Chen, Santa Clara, CA (US); Hui Chao, San Jose, CA (US); Saumitra Mohan Das, Santa Clara, CA (US)

(73) Assignee: QUALCOMM Incorporated, San Diego, CA (US)

(21) Appl. No.: 13/791,079

(22) Filed: Mar. 8, 2013

(51) Int. Cl. G01C 21/36; G06T 11/20

(52) U.S. Cl. CPC G01C 21/3682; G06T 11/20
USPC 701/426; 345/441

(57) ABSTRACT

An embodiment is directed to generating a polygon representation of a plurality of points of interest (POIs) in a scene having a corresponding base level map of the scene, and creating a new level map including a reduced number of polygon representations of POIs on the basis of elimination of POIs having a lower than specified POI importance level. In another embodiment, a mobile device (e.g., the user device) can specify the specified POI importance level to trigger the generation and delivery of the new level map which conforms to the specified POI importance level so that the new level map can be displayed to a user of the mobile device (e.g., in conjunction with navigation instructions to one or more of the remaining POIs).

### FIELD OF DISCLOSURE

Embodiments of the present invention relate to a method and architecture for creating and using multi-level geometry for indoor maps with different level of details.

### BACKGROUND

Electronic devices (cellular telephones, wireless modems, computers, digital music players, Global Positioning System units, Personal Digital Assistants, gaming devices, etc.) have become a part of everyday life. Small computing devices are now placed in everything from automobiles to housing locks. The complexity of electronic devices has increased dramatically in the last few years. For example, many electronic devices have one or more processors that help control the device, as well as a number of digital circuits to support the processor and other parts of the device.

Mobile devices now support many processor dependent applications. Navigation based on maps, supported, for example, by Global Positioning System satellites, has become quite popular.

For outdoor navigation, an earth map is stored as hierarchical tiles in image format.

Tiles are predefined and static and are at different resolution. Zoom level and location defines what tiles to take to compose the images on the screen. This format reduces the latency of getting the most relevant information for the user. However, such standards do not exist yet for indoor maps.

For indoor navigation, maps are often stored in Geography Markup Language (GML), a vector XML format encoding standard for geographic information developed by the OpenGIS Consortium (OGC). Currently most of GML maps (e.g. Destination Maps XML, by NAVTEQ® GML), have only a single level of the geometry of the venue (a flat structure), such as the polygon description of destinations or Points of Interest (POIs).

Current approaches do not provide multi-level geometry with different levels of details, which may not be flexible for display on different devices, or on a same device with different settings or in different scenarios.

### SUMMARY

An embodiment is directed to generating a polygon representation of a plurality of points of interest (POIs) in a scene having a corresponding base level map of the scene, and creating a new level map including a reduced number of polygon representations of POIs on the basis of elimination of POIs having a lower than specified POI importance level. In another embodiment, a mobile device (e.g., the user device) can specify the specified POI importance level to trigger the generation and delivery of the new level map which conforms to the specified POI importance level so that the new level map can be displayed to a user of the mobile device (e.g., in conjunction with navigation instructions to one or more of the remaining POIs).

### BRIEF DESCRIPTION OF THE DRAWINGS

FIG. 1 illustrates one configuration of a wireless communication system, in accordance with certain embodiments of the disclosure.

FIG. 2 illustrates a method of generating a display map based on a pyramid hierarchical reduction of data from a base map data structure in accordance with certain embodiments of the disclosure.

FIG. 3 is a graphical illustration of the method described in FIG. 2 in accordance with certain embodiments of the disclosure.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well known structures and devices are shown in block diagram form in order to avoid obscuring the concepts of the present invention.

A method is disclosed for creating and using multi-level geometry for indoor maps with different levels of detail. With a multi-level hierarchical structure from coarse to fine, this method can adjust the complexity of geometry loaded in mobile devices for display according to the context and resolution or zoom level. It may also reduce the latency and power consumption of map loading and information display as a result of the reduced volume of data received by or transmitted from the mobile device.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband CDMA (W-CDMA). CDMA2000 covers IS-2000, IS-95 and technology such as Global System for Mobile Communication (GSM).

An OFDMA network may implement a radio technology such as Evolved UTRA (E-UTRA), the Institute of Electrical and Electronics Engineers (IEEE) 802.11, IEEE 802.16, IEEE 802.20, Flash-OFDAM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE. Rather, the techniques described herein may be utilized in various application involving wireless transmissions, such as personal area networks (PANs), body area networks (BANs), location, Bluetooth, GPS, UWB, RFID, and the like. Further, the techniques may also be utilized in wired systems, such as cable modems, fiber-based systems, and the like.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ration (PAPR) because of its inherent single carrier structure. SC-FDMA may be used in the uplink communications where the lower PAPR greatly benefits the mobile terminal in terms of transmit power efficiency.

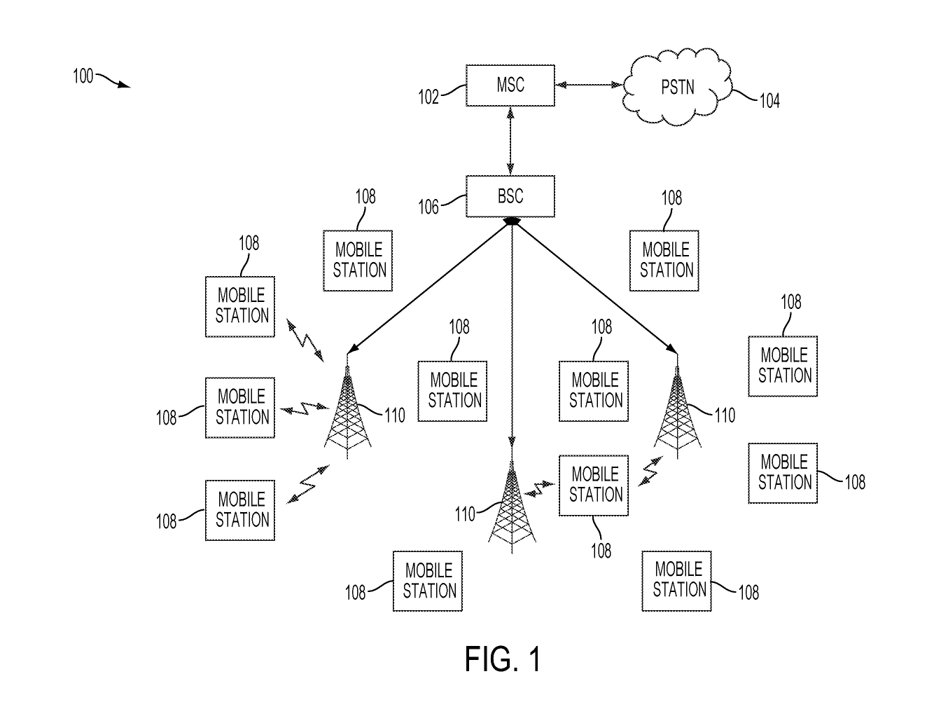

FIG. 1 illustrates a wireless system 100 that may include a plurality of mobile stations 108, a plurality of base stations 110, a base station controller (BSC) 106, and a mobile switching center (MSC) 102. The wireless system 100 may be GSM, EDGE, WCDMA, CDMA, etc. The MSC 102 may be configured to interface with a public switched telephone network (PTSN) 104. The MSC 102 may also be configured to interface with the BSC 106. There may be more than one BSC 106 in the wireless system 100. Each base station 110 may include at least one sector, where each sector may have an omnidirectional antenna or an antenna pointed in a particular direction radially away from the base stations 110. Alternatively, each sector may include two antennas for diversity reception. Each base station 110 may be designed to support a plurality of frequency assignments. The intersection of a sector and a frequency assignment may be referred to as a channel. The mobile stations 108 may include cellular or portable communication system (PCS) telephones.

During operation of the wireless system 100, the base stations 110 may receive sets of reverse link signals from sets of mobile stations 108. The mobile stations 108 may be involved in telephone calls or other communications. Each reverse link signal received by a given base station 110 may be processed within that base station 110. The resulting data may be forwarded to the BSC 106. The BSC 106 may provide call resource allocation and mobility management functionality including the orchestration of soft handoffs between base stations 110. The BSC 106 may also route the received data to the MSC 102, which provides additional routing services for interfacing with the PSTN 104. Similarly, the PTSN 104 may interface with the MSC 102, and the MSC 102 may interface with the BSC 106, which in turn may control the base stations 110 to transmit sets of forward link signals to sets of mobile stations 108.

An indoor map includes, for example a data structure of geometry of features (e.g., offices, elevators, restaurants, which may be referred to as points of interest (POI)) as a list of objects, such as polygons, for example, indicating one or more of location, size, name, etc. This may constitute the base layer of a “map pyramid.” At a higher level of detail, when required, in a next layer, the geometry of the map may be simplified, for example, to show only a region of the indoor map (e.g., a floor, a part of a floor, type of POI, etc.). Polygons, lines and other geometrical features and/or less important POIs may be removed from the layer. For example, if the POIs of interest are, e.g., law offices, all other features may be removed. If the POIs are related to safety and evacuation, only stairwells, exit doors, elevators, service shafts, etc., may be retained and offices may be removed.

An indoor map data structure is the core data in indoor navigation applications. Maps are formatted and stored in multi-level geometry pyramid structure from fine to coarse and from dense to thin. An application accessed by the user selects the most appropriate level from the map pyramid structure to display. The selection is based on a group of criteria including, but not limited to, one or more of the screen size of the device, the degree of zoom-in for a desired level of detail from user's input, the battery level, etc. The multi-level map geometry pyramid allows flexible display for various devices. Thus, a user may select a display with minimal detail to achieve fast data transfer with adequate navigation information, select more detail to provide more accurate geographical imaging and meta information about one or more POIs, or some intermediate level of detail. Thus, level selection in map display is driven by device constraints as well as by user need for detail, such as navigation to POIs. This mechanism is useful for widespread implementation on mobile phones for indoor navigation.

As the level of interest in a search is refined and narrowed, new levels of narrower content are created, until a top level of interest is reached containing a reduced amount of data, which allows for faster transfer of image data. Different levels of detail, according to POI definition, may be created as levels of a pyramid, from broadest level map of geometrical features “at the bottom” to narrowest level “at the top.” The various level maps may be stored in a map file for faster processing on a mobile device. Applications (“Apps”) on mobile devices may choose and retrieve the most appropriate level of POIs from the indoor map to display. The map generation may take place on a remote server, in which the user provides search input from the mobile device to the server, and a reduced set of information from the base level of the data structure is used to generate a map at a higher level that is less dense with data. The process of reducing complexity and data content (i.e., paring the data structure to a sub-structure) may be repeated automatically at the server until only the remaining POIs of sufficient importance are left, or the user provides additional input to change or refine the map results. The importance of a POI may be measured with a score that depends on the user's search key words and the area of bounding polygon of a POI. A server measures the importance score of each POI, merges small neighboring POIs into a complex-POI (or a POI group) with low importance score to create a larger bounding polygon to increase the importance score. A POI or complex-POI is chosen to be sent to the mobile device for display if its importance score is above a certain threshold.

An embodiment of the invention is directed to creating a group of indoor maps at multiple levels of detail according to POI search, and integrating the data structures into a map file in a pyramidal organization that may be accessed by a mobile device application. The map file may be stored remotely at the server, or one or more maps may be transmitted for storage on the mobile device.

The map file may include organization of the geometry of the scene. For example, each destination, or point of interest, (POI) in the scene may be described by a polygon line. The location (position) of the POI may be derived from actual geographical data (e.g., latitude and longitude), or in a self-defined coordinate system (e.g., where all position data are normalized to a bounding area), which may be computed offline and stored. For example, a POI may be represented by a simple polygon for the purpose of showing general location and an indication of size of the POI. Alternatively, the polygon representation may be complicated, in order to more accurately portray the physical layout of the POI. Furthermore, the polygon representation chosen may be normalized to scale within the bounding area (such as the property limits of a mall or department store), or they may be displayed as oversized to emphasize the POI in the display.

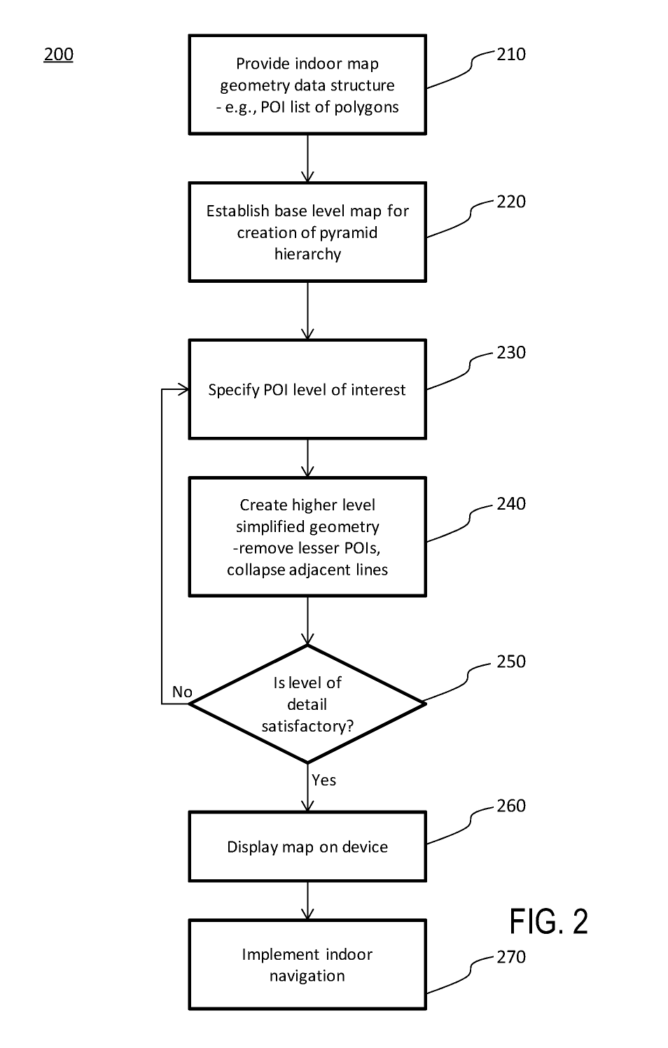

FIG. 2 illustrates a method 200 of generating a display map based on a pyramid hierarchical reduction of data from a base map data structure. In method block 210 a base level data structure of an indoor map is provided, containing the geometry of the indoor environment. The data structure includes all geometric details for features of all possible POIs, such as a mall, department store, office building, etc., and which may be stored as a file on a remote server.

In a 2-dimensional (2D) indoor map, a list of line loops or coordinate points for POIs in the scene is generated to define a polygon representing each POI. The polygon may be complex enough to provide a recognizable rendering of a POI (e.g., the layout of a restaurant or department store in a mall), however, an aspect of the disclosure is to provide a map with at least a threshold amount of detail for permitting location and navigation to the POI by providing a reduced amount of data over a communications network to the user mobile device.

Many potential points of interest (POIs) may be identified and located, where the POIs have different levels of relevance and importance based on a user's objective and preferred destination. The POIs may be represented, for example, by simple polygon approximations, cross-hairs, “pins,” etc. depending on the size of the POI relative to the level of resolution of the map.

In method block 220, a base level map as a data structure may be created—the “base” of a pyramid—that may include a set of possible indoor features of the environment of a property of interest. In an example, there may be no filtering out of features that may be of interest in a particular context. At this level, polygon representations of POIs may be accurate to some standard level of detail (e.g., on the scale of 1 ft. increments, or larger) and stored in the base level of the pyramid data structure, but which may not be practically displayed at this level of detail, depending on the resolution of the display device (i.e., a feature of the polygon would have to be greater than one display pixel to be displayable). Metadata describing properties of the POI may also be included at this level.

In order to reduce data storage, data transfer, and processing demand on a mobile device, the base level data structure, from which any map may be constructed, may be stored on a server remote from mobile device. Depending on the processing capability and power storage capacity of the remote device, the base level data structure, or parts of it, may be downloaded to and maintained on the mobile device, where the downloaded portions of the data structure may be locally processed.

In method block 230, a user interacting with the mobile device may specify one or more points of interest. For example, the user may be a consumer searching for all shoe vendors in a shopping mall, or a safety inspection officer searching for all fire extinguisher and sprinkler shut-off control valve locations. The POI level of interest represents a list of features of interest to the user, which may be transmitted to the server (if such data has not been downloaded to the mobile device). The user application on the mobile device thus generates a list of data types (POIs), which may be transmitted to the remote server, for generation of a reduced (“thinned” or “child”) data structure from which a map of reduced complexity may be constructed.

The list of POIs corresponding to the specified user input may be used, in method block 240, to create a higher level data structure, from which a map may be constructed, to simplify the map geometry by including only the specified POIs, or types of POIs, of sufficient interest, and removing others of lesser interest. The geometry of indoor objects may be simplified in various ways according to various criteria and/or level of importance. For example, line segments with joint angles that are close to 180 degree and adjoining parallel lines may be recursively collapsed. The angle threshold for collapsing line segments may be preset. This renders a map that may be composed from the POI list with less clutter from features of little or no interest to the user. In some cases two or more POIs may be adjacent, or may be related. For example, in a department store, there may be adjacent men's, women's and children's shoe departments. If the user defined POI search designates only “shoes,” the three separate departments may be collapsed into a single structure, where the adjacent boundaries of the several departments are removed to render a single object for display representing all three. Thus, geometrical features representing objects that are not necessary for display at the new level may be removed.

In one embodiment, the child data structure may be transmitted to the mobile device, which is adapted to create a map with a user application and information in the child data structure. Alternatively, the simplified map may be constructed at the server, and transmitted to the mobile device using less bandwidth or transmission time.

In decision block 250, a determination is made, based on user response or, concurrently, on the context of the search for POIs, whether the level of detail is satisfactory for the user to locate one or more POIs. If the user decides, for example, that the search should be made further selective, such as seeking only “women's shoes,” the method may resume at method block 230, where the POI level of interest is more narrowly specified. Alternatively, the user may wish to broaden the interest to locate vendors of both women's shoes and handbags, and the method continues until the level of detail is satisfactorily achieved in decision block 250. Similarly, a plurality of eateries in a food court may be collapsed into a single object, such as a “food court.”

At that point, the mobile device assembles a data structure (whether from internally stored data or from the remote server) to construct a map for display (method block 260) based on the level of detail required to satisfy the interest level for the specified POIs. In this manner, the various levels of a map pyramid are stored in a map file as child data structures descending from the parent. The map file may be stored on a remote server or processor. The mobile device parses the map pyramid data from the file and dynamically chooses the most appropriate level of map to display. The selection of the most appropriate map level is based on a group of criteria, which may include the screen size, screen resolution, current zoom-in level, and/or battery level. In an example, the map level may be constructed at the remote server or processor to contain only the features that permit navigation when displayed on the mobile device. Thus, for example, navigation from a mall entrance to a particular store or food court may show a skeletal plan of the mall with the location of the mobile device and the destination location, with a line connector showing a path between them. The relevant walkway and the POI may be shown, but all other features may be absent from the displayed map, the consequence of which is a display with reduced data content that required a reduced amount of broadcast bandwidth and receiver stored energy to display relative to a fully detailed map.

Map information is stored in a multilevel hierarchical structure from coarse to fine. For example, at higher levels (i.e., large overview displays, as in a parent node in XML), some structures may be merged or ignored. For example, a food court may be formed as a data feature without indicating individual restaurants or food service counters, or a department store may be represented as a single entity without specifying/displaying individual departments. At higher levels (e.g., a child node in XML), structures may be described in more detail, e.g. with small line segments and polygons, and including metadata describing the POI structure. Data may be requested from a higher level in the pyramid by the mobile device to reduce the amount of data sent to the mobile device. For example, a display pertaining only to a food court may show individual dining services, or in a department store, the location of various departments.

The displayed map includes less than the maximum available data from the parent data structure. This has the advantage of requiring less data to be received by the mobile device and requires less power to process the thinner (“child”) data structure and provide a simpler map without features that are of lesser or no interest.

The user may then seek directions to navigate (method block 270) from a current location to one or more of the remaining POIs. The result is that far less data, processing time and battery energy are required to serve the user with the desired functionality.

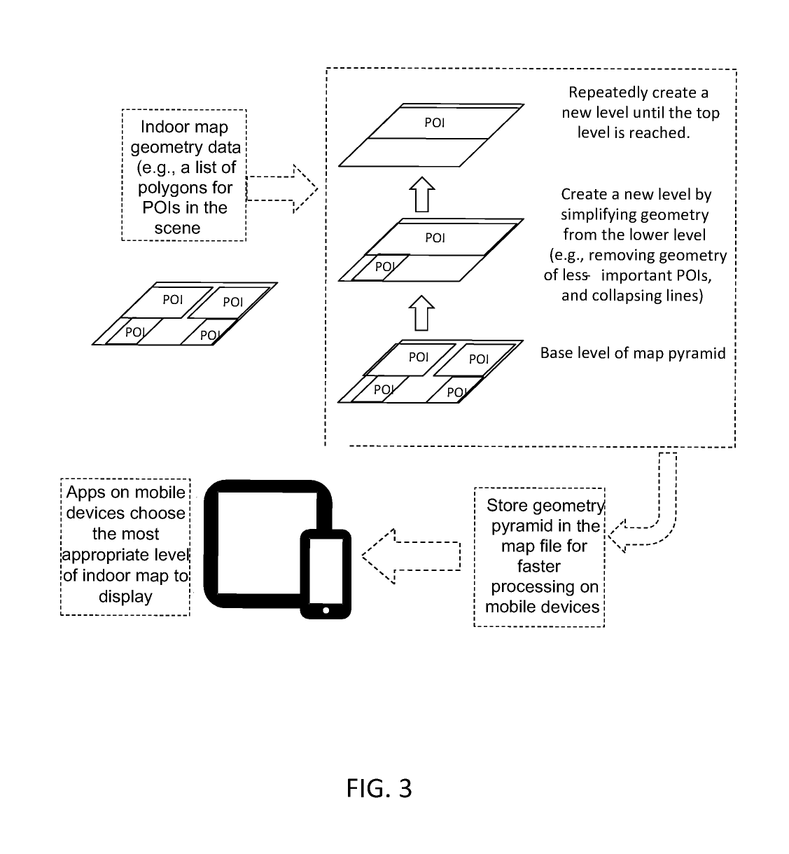

FIG. 3 illustrates graphically the method described in FIG. 2. An indoor map of geometry data of all POIs represented, for example, as a list of polygons is provided as a parent data structure. A base level map may be constructed to include a set of POIs. When less important POIs are absent from a list of specified POI types, a new level of child data structure, simplified by the absence of unimportant POIs, is formed, from which a simplified map may be formed. The process may be repeated for a narrower definition of POIs searched until a “top level” is reached, in which only the required POI locations are left to form a map. The application on the mobile device may then choose the level of map that is most appropriate to display, based on satisfying the criteria for including the POIs with sufficient level of importance according to the specified level of interest.

The reduced data structure of geometric data may be stored in a map file for faster retrieval and processing on the mobile device than may be done with the parent data structure to quickly and efficiently produce a simple and useful map, containing only features necessary for a given navigation task.

Map rendering is one of the most energy-costly parts in indoor navigation related applications on mobile devices. The cost is roughly proportional to the complexity of the scene geometry. It may be appreciated that the disclosed method can reduce the energy consumption and extend the battery life for mobile indoor navigation by rendering and loading maps from a remote server with the most appropriate level of geometry detail required for a task, such as navigating. Furthermore, display quality may be improved by rendering fewer geometric objects on the display, and reducing aliasing.

The previous description is provided to enable any person skilled in the art to practice the various aspects described herein. Various modifications to these aspects will be readily apparent to those skilled in the art, and the generic principles defined herein may be applied to previous or other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of generating map data in a hierarchical pyramid data structure for display on a user device comprising:
generating in a parent node a data structure of polygon representation of a plurality of points of interest (POIs) in a scene having a corresponding base level map of the scene; and
creating a new level map in a child node including a reduced number of polygon representations of POIs by elimination of POIs having a lower than specified level of importance.

2. The method of claim 1, wherein each of the plurality of POIs is associated with one of a plurality of levels of importance, wherein the plurality of levels of importance comprise at least one of HIGH importance and LOW/NO importance.

3. The method of claim 1, wherein the scene is an interior environment.

4. The method of claim 1, further comprising:
repeating creating a new level map from a current level map on the basis of repeated communications from the user device that are indicative of an updated narrower specified level of importance of POIs until the updated specified level of importance is no longer further updated to a narrower specified level.

5. The method of claim 4, further comprising repeating creating a new level map until only POIs equaling or exceeding a most recent updated narrower specified level of importance remain.

6. The method of claim 5, wherein each new level map is stored as a pyramidally arranged hierarchy of successively dependent child node data sub-structures.

7. The method of claim 6, further comprising:
obtaining a selection from the user device of a map level for display on the user device that is based on one or more of device screen size, zoom-in for desired level of detail and/or battery power level.

8. The method of claim 7, further comprising:
generating the selected map level at a remote server coupled to the user device by wireless communication; and
storing the generated map level in the hierarchical pyramid data structure on the remote server.

9. The method of claim 8, further comprising delivering the generated map level for display on the user device.

10. A method of facilitating navigation at a mobile device using map data in a hierarchical pyramid data structure, comprising:
accessing a parent data file including a polygon representation of a plurality of points of interest (POIs) in a scene, wherein the parent data file comprises a generated hierarchical data structure of maps arranged pyramidally with successive levels of detail on the basis of importance of POIs by one or more specified criteria;
specifying a level of importance of one or more POIs from among the plurality of POIs;
retrieving a map from the parent data file with a level of map that is generated on the basis of the specified level of importance; and
displaying the map on the mobile device.

11. The method of claim 10, wherein the levels of importance comprise at least HIGH importance and LOW/NO importance.

12. The method of claim 10, wherein the scene is an interior environment.

13. The method of claim 10, wherein the level of map is generated by repeatedly removing POIs from the scene that do not satisfy the specified level of importance.

14. The method of claim 10, wherein the specified level of importance is based on at least one of device screen size, zoom-in for desired level of detail, and battery power level.

15. The method of claim 10, wherein the map is retrieved from a remote server.

16. The method of claim 10, further comprising:
downloading, from a remote server, a navigation route from a current location of the mobile device to a target POI; and
displaying the navigation route in conjunction with the display of the map on the mobile device.

17. A computing apparatus configured to generate map data in a hierarchical pyramid data structure for display on a user device comprising:
means for generating in a parent node a data structure of polygon representation of a plurality of points of interest (POIs) in a scene having a corresponding base level map of the scene; and
means for creating a new level map in a child node including a reduced number of polygon representations of POIs by elimination of POIs having a lower than specified level of importance.

18. A mobile device configured to use map data in a hierarchical pyramid data structure, comprising:
means for accessing a parent data file including a polygon representation of a plurality of points of interest (POIs) in a scene, wherein the parent data file comprises a generated hierarchical data structure of maps arranged pyramidally with successive levels of detail on the basis of importance of POIs by one or more specified criteria;
means for specifying a level of importance of one or more POIs from among the plurality of POIs;
means for retrieving a map from the parent data file with a level of map that is generated on the basis of the specified level of importance; and
means for displaying the map on the mobile device.

19. A computing apparatus configured to generate map data in a hierarchical pyramid data structure for display on a user device comprising:
a processor configured to:
generate in a parent node a data structure of polygon representation of a plurality of points of interest (POIs) in a scene having a corresponding base level map of the scene; and
create a new level map in a child node including a reduced number of polygon representations of POIs by elimination of POIs having a lower than specified level of importance.

20. A mobile device configured to use map data in a hierarchical pyramid data structure, comprising:
a processor configured to:
access a parent data file including a polygon representation of a plurality of points of interest (POIs) in a scene, wherein the parent data file comprises a generated hierarchical data structure of maps arranged pyramidally with successive levels of detail on the basis of importance of POIs by one or more specified criteria;
specify a level of importance of one or more POIs from among the plurality of POIs;
retrieve a map from the parent data file with a level of map that is generated on the basis of the specified level of importance; and
display the map on the mobile device.

21. A non-transitory computer-readable medium containing instructions stored thereon, which, when executed by a computing apparatus configured to generate map data in a hierarchical pyramid data structure for display on a user device, cause the computing apparatus to perform operations, the instructions comprising:
at least one instruction to cause the computing apparatus to generate in a parent node a data structure of polygon representation of a plurality of points of interest (POIs) in a scene having a corresponding base level map of the scene; and
at least one instruction to cause the computing apparatus to create a new level map in a child node including a reduced number of polygon representations of POIs by elimination of POIs having a lower than specified level of importance.

22. A non-transitory computer-readable medium containing instructions stored thereon, which, when executed by a mobile device configured to use map data in a hierarchical pyramid data structure, cause the mobile device to perform operations, the instructions comprising:
at least one instruction to cause the computing apparatus to access a parent data file including a polygon representation of a plurality of points of interest (POIs) in a scene, wherein the parent data file comprises a generated hierarchical data structure of maps arranged pyramidally with successive levels of detail on the basis of importance of POIs by one or more specified criteria;
at least one instruction to cause the computing apparatus to specify a level of importance of one or more POIs from among the plurality of POIs;
at least one instruction to cause the computing apparatus to retrieve a map from the parent data file with a level of map that is generated on the basis of the specified level of importance; and
at least one instruction to cause the computing apparatus to display the map on the mobile device.
